(19) United States
(12) Patent Application Publication
(10) Pub. No.: US 2026/0254105 A1
(43) Pub. Date: Aug. 27, 2026

(54) ZIPPER DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/073,866

(22) Filed: Mar. 7, 2025

(30) Foreign Application Priority Data
Feb. 26, 2025 (TW) 114107121

(51) Int. Cl. H01Q 1/44; A44B 19/26

(52) U.S. Cl. CPC H01Q 1/44; A44B 19/26

(57) ABSTRACT

A zipper device includes a puller, a dielectric layer, a connection metal element, and a signal source. The puller includes a first metal element and a second metal element. The dielectric layer is configured to separate the first metal element from the second metal element. The connection metal element is coupled to the second metal element. The signal source has a positive electrode and a negative electrode. An antenna structure is formed by the first metal element, the second metal element, the dielectric layer, and the connection metal element. The antenna structure is configured to receive or transmit a wireless signal.

### CROSS REFERENCE TO RELATED APPLICATIONS

This application claims priority of Taiwan Patent Application No. 114107121 filed on Feb. 26, 2025, the entirety of which is incorporated by reference herein.

### BACKGROUND OF THE INVENTION

### Field of the Invention

The invention relates to a zipper device, and more particularly, to a zipper device with a function of wireless communication and a communication method thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has insufficient operational bandwidth, it may degrade the communication quality of the relative mobile device. Accordingly, it has become a critical challenge for designers to design a small-size, wideband antenna structure.

### BRIEF SUMMARY OF THE INVENTION

In an exemplary embodiment, the invention is directed to a zipper device that includes a puller, a dielectric layer, a connection metal element, and a signal source. The puller includes a first metal element and a second metal element. The dielectric layer is configured to separate the first metal element from the second metal element. The connection metal element is coupled to the second metal element. The signal source has a positive electrode and a negative electrode. An antenna structure is formed by the first metal element, the second metal element, the dielectric layer, and the connection metal element. The antenna structure is configured to receive or transmit a wireless signal.

In some embodiments, the first metal element is a top metal board.

In some embodiments, the second metal element is a bottom metal board.

In some embodiments, a window region is formed between the first metal element and the second metal element.

In some embodiments, the puller further includes a cover, and the cover is disposed on the first metal element.

In some embodiments, the thickness of the dielectric layer is from 0.1 mm to 0.5 mm.

In some embodiments, the connection metal element is implemented with a screw.

In some embodiments, the signal source is an RF (Radio Frequency) module.

In some embodiments, the signal source is embedded in the zipper device or a dongle element.

In some embodiments, the antenna structure operates in a low frequency band and a high frequency band.

In some embodiments, the low frequency band is from 2400 MHz to 2500 MHz.

In some embodiments, the high frequency band is from 5150 MHz to 7125 MHz.

In some embodiments, the length of the first metal element is from 0.0625 to 0.25 wavelength of the low frequency band.

In some embodiments, the length of the second metal element is from 0.0625 to 0.25 wavelength of the low frequency band.

In some embodiments, the length of the connection metal element is from 0.01 to 0.1 wavelength of the low frequency band.

In some embodiments, the zipper device further includes a plurality of first zipper teeth and a plurality of second zipper teeth. The second zipper teeth are interleaved with the first zipper teeth. The antenna structure is adjacent to the first zipper teeth and the second zipper teeth.

In some embodiments, the first zipper teeth and the second zipper teeth are configured to enhance the radiation efficiency of the antenna structure.

In some embodiments, the first zipper teeth and the second zipper teeth directly touch each other.

In some embodiments, the total length of the first zipper teeth and the second zipper teeth is from 0.0625 to 0.25 wavelength of the low frequency band.

In another exemplary embodiment, the invention is directed to a communication method that includes the steps of: providing a puller, a dielectric layer, a connection metal element, and a signal source, wherein the puller includes a first metal element and a second metal element, the dielectric layer is configured to separate the first metal element from the second metal element, and the connection metal element is coupled to the second metal element; forming an antenna structure by the first metal element, the second metal element, the dielectric layer, and the connection metal element; and receiving or transmitting a wireless signal by the antenna structure.

### BRIEF DESCRIPTION OF DRAWINGS

The invention can be more fully understood by reading the subsequent detailed description and examples with references made to the accompanying drawings, wherein:

FIG. 1A is a perspective view of a zipper device according to an embodiment of the invention;

FIG. 1B is a sectional view of a zipper device according to an embodiment of the invention;

FIG. 2 is a perspective view of a zipper device according to an embodiment of the invention;

FIG. 3 is a perspective view of a zipper device according to an embodiment of the invention; and

FIG. 4 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

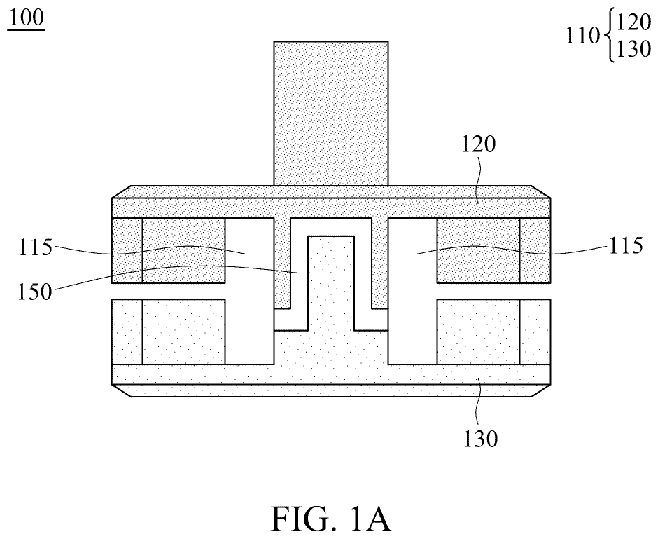

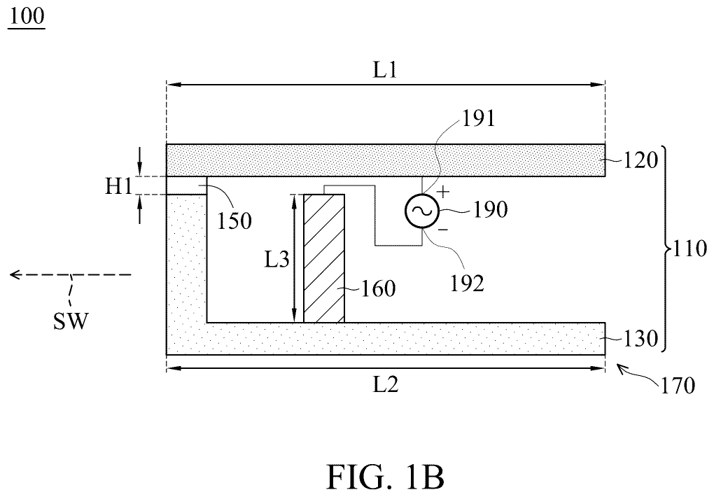

FIG. 1A is a perspective view of a zipper device 100 according to an embodimen of the invention. FIG. 1B is a sectional view of the zipper device 100 according to an embodiment of the invention. Please refer to FIG. 1A and FIG. 1B together. As shown in FIG. 1A and FIG. 1B, the zipper device 100 includes a puller 110, a dielectric layer 150, a connection metal element 160, and a signal source 190. The puller 110 may be made of a metal material, such as copper, silver, aluminum, iron, or their alloys. It should be understood that the zipper device 100 may include other components, such as a puller, a connector, and/or a plurality of zipper teeth, although they are not displayed in FIG. 1A and FIG. 1B.

The puller 110 includes a first metal element 120 and a second metal element 130 which are adjacent to each other. For example, the first metal element 120 may be a top metal board of the puller 110, the second metal element 130 may be a bottom metal board of the puller 110, and they may be disposed and substantially parallel to each other. The shapes and types of the first metal element 120 and the second metal element 130 are not limited in the invention. In some embodiments, a window region 115 is formed between the first metal element 120 and the second metal element 130, and it is configured to accommodate one or more zipper teeth. It should also be noted that the term “adjacent” or “close” over the disclosure means that the distance (spacing) between two corresponding elements is smaller than a predetermined distance (e.g., 5 mm or the shorter), or mean that the two corresponding elements directly touch each other (i.e., the aforementioned distance/spacing between them is reduced to 0).

The dielectric layer 150 is made of a nonconductive material, such as an ABS (Acrylonitrile Butadiene Styrene) plastic material. The dielectric layer 150 is configured to separate the first metal element 120 from the second metal element 130, such that the first metal element 120 and the second metal element 130 do not directly touch each other. In some embodiments, the dielectric layer 150 is configured to cover a protruding portion of the second metal element 130, and the dielectric layer 150 is also embedded in a concave region of the first metal element 120.

The connection metal element 160 is coupled to the second metal element 130. For example, the connection metal element 160 may be substantially perpendicular to both the first metal element 120 and the second metal element 130, but it is not limited thereto.

For example, the signal source 190 may be an RF (Radio Frequency) module. Specifically, the signal source 190 has a positive electrode 191 and a negative electrode 192. The positive electrode 191 of the signal source 190 is coupled to the first metal element 120. The negative electrode 192 of the signal source 190 is coupled to the connection metal element 160. However, the invention is not limited thereto. In alternative embodiments, the positive electrode 191 and the negative electrode 192 of the signal source 190 are exchanged with each other, but this does not affect the function of the signal source 190.

In a preferred embodiment, an antenna structure 170 of the zipper device 100 is formed by the first metal element 120, the second metal element 130, the dielectric layer 150, and the connection metal element 160. The antenna structure 170 is configured to receive or transmit a wireless signal SW. For example, the wireless signal SW may be an RF signal.

In some embodiments, the antenna structure 170 of the zipper device 100 can cover a low frequency band and a high frequency band. For example, the low frequency band may be from 2400 MHz to 2500 MHz, and the high frequency band may be from 5150 MHz to 7125 MHz. Accordingly, the antenna structure 170 of the zipper device 100 can support at least the wideband operations of WLAN (Wireless Local Area Network), Wi-Fi 6E, Wi-Fi 7, and UWB (Ultra-Wideband).

In some embodiments, the operational principles of the antenna structure 170 of the zipper device 100 will be described as follows. In the puller 110, the first metal element 120 is used as a feeding radiation element of the antenna structure 170, and the second metal element 130 is used as a grounding radiation element of the antenna structure 170. According to practical measurements, the connection metal element 160 is configured to fine-tune the impedance matching of the antenna structure 170. With the proposed design of the invention, the first metal element 120 and the second metal element 130 are excited to generate a fundamental resonant mode, thereby forming the aforementioned low frequency band. In addition, the first metal element 120 and the second metal element 130 are further excited to generate a higher-order resonant mode, thereby forming the aforementioned high frequency band. Since the zipper device 100 with the function of wireless communication is capable of being integrated with any clothing element of a user, it not only supports the desired wideband operations but also helps to reduce the overall antenna size.

In some embodiments, the element sizes of the zipper device 100 will be described as follows. The length L1 of the first metal element 120 may be from 0.0625 to 0.25 wavelength (λ/16~λ/4) of the low frequency band of the antenna structure 170 of the zipper device 100, such as about 0.125 wavelength (λ/8). The length L2 of the second metal element 130 may be from 0.0625 to 0.25 wavelength (λ/16~λ/4) of the low frequency band of the antenna structure 170 of the zipper device 100, such as about 0.125 wavelength (λ/8). The thickness H1 of the dielectric layer 150 may be from 0.1 mm to 0.5 mm. The length L3 of the connection metal element 160 may be from 0.01 to 0.1 wavelength (λ/100~λ/10) of the low frequency band of the antenna structure 170 of the zipper device 100, such as about 0.05 wavelength (λ/20). The above ranges of element sizes are calculated and obtained according to many experimental results, and they help to optimize the operational bandwidth and the impedance matching of the antenna structure 170 of the zipper device 100 and also to minimize the overall size of the zipper device 100.

The following embodiments will introduce different configurations and detail structural features of the zipper device 100. It should be understood that these figures and descriptions are merely exemplary, rather than limitations of the invention.

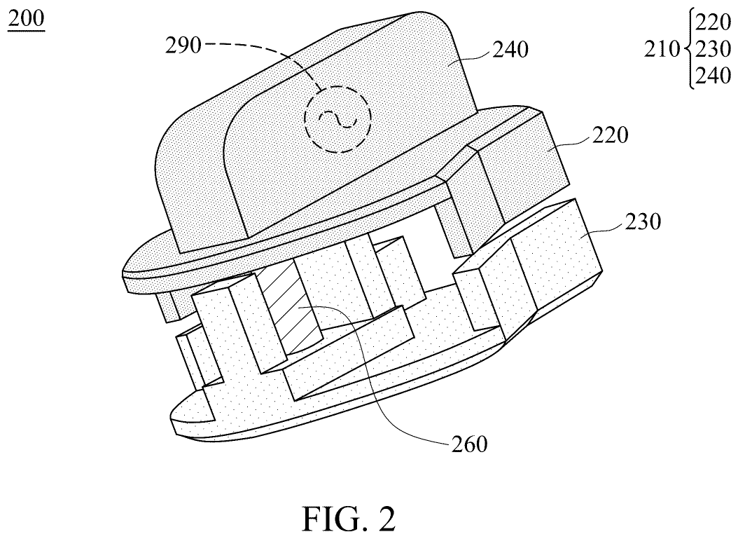

FIG. 2 is a perspective view of a zipper device 200 according to an embodiment of the invention. FIG. 2 is similar to FIG. 1A and FIG. 1B. In the embodiment of FIG. 2, a puller 210 of the zipper device 200 includes a first metal element 220, a second metal element 230, and a cover 240, and a connection metal element 260 of the zipper device 200 is implemented with a screw. For example, the cover 240 may be made of a metal material or a nonconductive material, and it may be disposed on the first metal element 220. In some embodiments, a signal source 290 of the zipper device 200 is embedded in the zipper device 200 (or its cover 240), so as to save the corresponding design space. In addition, a dongle element (not shown) may be detachably coupled to the first metal element 220 or the second metal element 230, and the signal source 290 may be disposed inside the dongle element. In some embodiment, the second metal element 230 has an opening, and the connection metal element 260 passes through the opening of the second metal element 230 and extends toward the first metal element 220. Other features of the zipper device 200 of FIG. 2 are similar to those of the zipper device 100 of FIG. 1A and FIG. 1B. Accordingly, the two embodiments can achieve similar levels of performance.

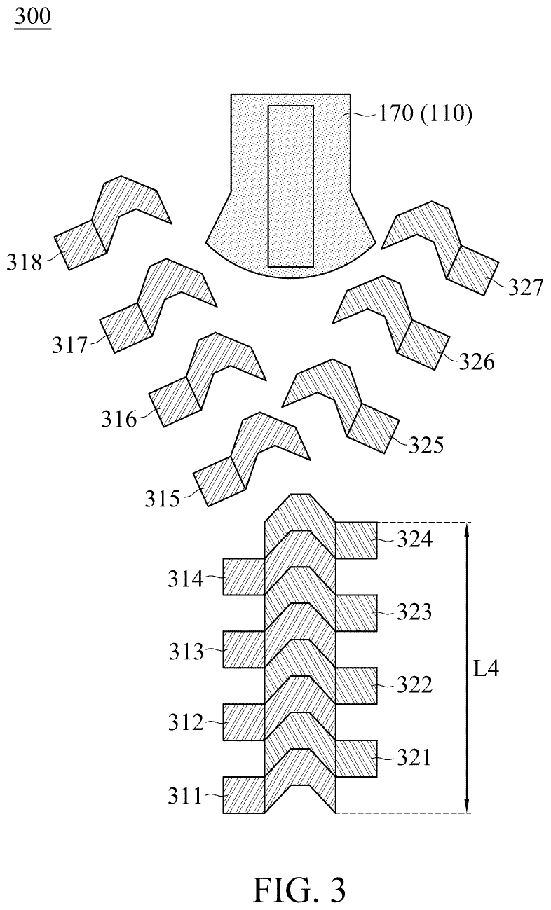

FIG. 3 is a perspective view of a zipper device 300 according to an embodiment of the invention. FIG. 3 is similar to FIG. 1A and FIG. 1B. In the embodiment of FIG. 3, the zipper device 300 further includes a plurality of first zipper teeth 311, 312, 313, 314, 315, 316, 317 and 318 and a plurality of second zipper teeth 321, 322, 323, 324, 325, 326 and 327. The second zipper teeth 321, 322, 323, 324, 325, 326 and 327 are interleaved with the first zipper teeth 311, 312, 313, 314, 315, 316, 317 and 318. It should be understood that the zipper device 300 may include more or less first zipper teeth and second zipper teeth. The aforementioned antenna structure 170 (or the puller 110) is adjacent to the first zipper teeth 311, 312, 313, 314, 315, 316, 317 and 318 and the second zipper teeth 321, 322, 323, 324, 325, 326 and 327. In some embodiments, the partial first zipper teeth 311, 312, 313 and 314 directly touch the partial second zipper teeth 321, 322, 323 and 324, but the other first zipper teeth 315, 316, 317 and 318 are separate from the other second zipper teeth 325, 326 and 327. For example, the total length L4 of the first zipper teeth 311, 312, 313 and 314 and the second zipper teeth 321, 322, 323 and 324 may be from 0.0625 to 0.25 wavelength (λ/16~λ/4) of the low frequency band of the antenna structure 170, such as about 0.125 wavelength (λ/8), but it is not limited thereto. According to practical measurements, the first zipper teeth 311, 312, 313 and 314 and the second zipper teeth 321, 322, 323 and 324 can resonate with the antenna structure 170, thereby enhancing the radiation efficiency of the antenna structure 170. Other features of the zipper device 300 of FIG. 3 are similar to those of the zipper device 100 of FIG. 1A and FIG. 1B. Accordingly, the two embodiments can achieve similar levels of performance.

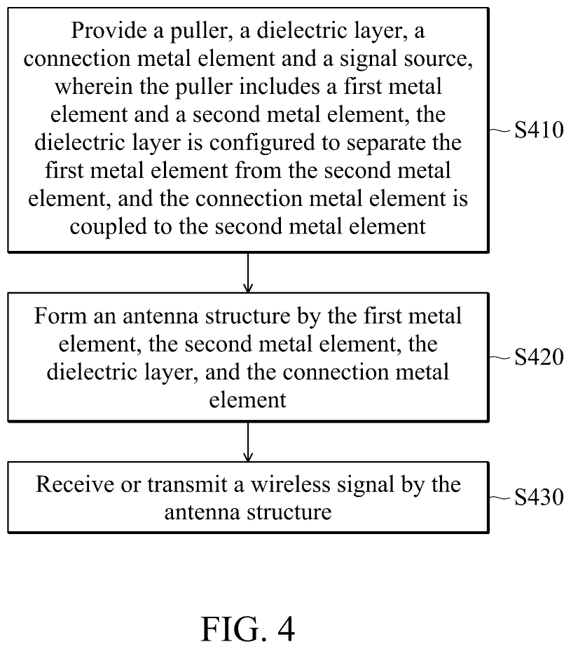

FIG. 4 is a flowchart of a communication method according to an embodiment of the invention. To begin, in step S410, a puller, a dielectric layer, a connection metal element, and a signal source are provided. The puller includes a first metal element and a second metal element. The dielectric layer is configured to separate the first metal element from the second metal element. The connection metal element is coupled to the second metal element. In step S420, an antenna structure is formed by the first metal element, the second metal element, the dielectric layer, and the connection metal element. Finally, in step S430, a wireless signal is received or transmitted by the antenna structure. It should be understood that these steps are not required to be performed in order, and every feature of the embodiments of FIGS. 1A to 3 may be applied to the communication method of FIG. 4.

The invention proposes a novel zipper device and a novel communication method. According to practical measurements, the communication device at least has the advantages of small size, wide bandwidth, and being easily integrated with any clothing element. Therefore, the invention is suitable for application in a variety of devices.

Note that the above element sizes and frequency ranges are not limitations of the invention. An antenna designer can fine-tune these setting values according to different requirements. It should be understood that the zipper device and the communication method of the invention are not limited to the configurations of FIGS. 1A to 4. The invention may include any one or more features of any one or more embodiments of FIGS. 1A to 4. In other words, not all of the features displayed in the figures should be implemented in the zipper device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A zipper device, comprising:
a puller, comprising a first metal element and a second metal element;
a dielectric layer, separating the first metal element from the second metal element;
a connection metal element, coupled to the second metal element; and
a signal source, having a positive electrode and a negative electrode;
wherein an antenna structure is formed by the first metal element, the second metal element, the dielectric layer, and the connection metal element;
wherein the antenna structure is configured to receive or transmit a wireless signal.

2. The zipper device as claimed in claim 1, wherein the first metal element is a top metal board.

3. The zipper device as claimed in claim 1, wherein the second metal element is a bottom metal board.

4. The zipper device as claimed in claim 1, wherein a window region is formed between the first metal element and the second metal element.

5. The zipper device as claimed in claim 1, wherein the puller further comprises a cover, and the cover is disposed on the first metal element.

6. The zipper device as claimed in claim 1, wherein a thickness of the dielectric layer is from 0.1 mm to 0.5 mm.

7. The zipper device as claimed in claim 1, wherein the connection metal element is implemented with a screw.

8. The zipper device as claimed in claim 1, wherein the signal source is an RF (Radio Frequency) module.

9. The zipper device as claimed in claim 1, wherein the signal source is embedded in the zipper device or a dongle element.

10. The zipper device as claimed in claim 1, wherein the antenna structure operates in a low frequency band and a high frequency band.

11. The zipper device as claimed in claim 10, wherein the low frequency band is from 2400 MHz to 2500 MHz.

12. The zipper device as claimed in claim 10, wherein the high frequency band is from 5150 MHz to 7125 MHz.

13. The zipper device as claimed in claim 10, wherein a length of the first metal element is from 0.0625 to 0.25 wavelength of the low frequency band.

14. The zipper device as claimed in claim 10, wherein a length of the second metal element is from 0.0625 to 0.25 wavelength of the low frequency band.

15. The zipper device as claimed in claim 10, wherein a length of the connection metal element is from 0.01 to 0.1 wavelength of the low frequency band.

16. The zipper device as claimed in claim 10, further comprising:
a plurality of first zipper teeth; and
a plurality of second zipper teeth, interleaved with the first zipper teeth, wherein the antenna structure is adjacent to the first zipper teeth and the second zipper teeth.

17. The zipper device as claimed in claim 16, wherein the first zipper teeth and the second zipper teeth are configured to enhance radiation efficiency of the antenna structure.

18. The zipper device as claimed in claim 16, wherein the first zipper teeth and the second zipper teeth directly touch each other.

19. The zipper device as claimed in claim 18, wherein a total length of the first zipper teeth and the second zipper teeth is from 0.0625 to 0.25 wavelength of the low frequency band.

20. A communication method, comprising the steps of:
providing a puller, a dielectric layer, a connection metal element and a signal source, wherein the puller comprises a first metal element and a second metal element, the dielectric layer is configured to separate the first metal element from the second metal element, and the connection metal element is coupled to the second metal element;
forming an antenna structure by the first metal element, the second metal element, the dielectric layer, and the connection metal element; and
receiving or transmitting a wireless signal by the antenna structure.
